(19) United States
(12) Patent Application Publication
(10) Pub. No.: US 2008/0158886 A1
(43) Pub. Date: Jul. 3, 2008

(54) Compact High-Intensity LED Based Light Source

(76) Inventors: Siew It Pang, Penang (MY); Shanmugam Chettiar, Penang (MY); Thye Linn Mok, Penang (MY)

Correspondence Address: Kathy Manke;Avago Technologies Limited, 4380 Ziegler Road, Fort Collins, CO, 80525, US

(21) Appl. No.: 11/618,459

(22) Filed: Dec. 29, 2006

(51) Int. Cl. F21V 29/00

(52) U.S. Cl. 362/294; 362/247

(57) ABSTRACT

A light source having a plurality of dies, an LED carrier, and a cover. Each die includes an LED. The LED carrier includes a metallic core having a top and a bottom surface, the dies are bonded to a circuit layer on the top surface of the core. The cover is bonded to the LED carrier and includes an opening having reflective sides that allows light from the LEDs to leave the cover. A dome-shaped encapsulant layer covers each of the dies. The encapsulant layer is spaced from the sides of the opening such that there is an air gap between the encapsulant layers and the sides. The air gap is positioned such that light leaving the side surfaces of the dies passes through the air gap before being reflected by one of the sides.

### BACKGROUND OF THE INVENTION

Light-emitting diodes (LEDs) are attractive replacement candidates for conventional light sources based on incandescent bulbs and fluorescent light tubes. LEDs have higher energy conversion efficiency than incandescent lights and substantially longer lifetimes than both incandescent and fluorescent light fixtures. In addition, LED-based light fixtures do not require the high voltages associated with fluorescent lights.

LEDs are particularly attractive light sources for backlit displays such as LCD panels that have space constraints. Many mobile electronic devices require a very thin backlight source. LCD displays for use in cellular telephones, PDAs, and laptop computers require a light source for illuminating an LCD panel or keypad. The light source typically consists of a thin two-dimensional flat light pipe that is illuminated from an edge or edges of the thin layer. Light is trapped within the light pipe by internal reflection until the light is scattered by scattering centers on one of the surfaces. The scattered light exits the light pipe through one surface of the light pipe and is used to illuminate a two-dimensional object such as an LCD panel or keypad.

Portable devices place severe constraints on the thickness of the light source. The minimum thickness of the device is set by the combined thickness of the light pipe and the object being illuminated. Ideally, the light source that is used to illuminate the edge of the light pipe is less than this minimum thickness so that the LEDs do not increase the thickness of the device. Since LEDs are inherently small light emitters that can operate on the low voltages available in such portable devices, light sources based on LEDs are of great interest in such applications.

Unfortunately, LEDs have a number of problems that must be overcome to provide a cost-effective solution in such backlight systems. First, LEDs are relatively low power point sources. The backlighting applications require a light source that has a linear geometry and more power than is available from a single LED. Hence, a light source having a relatively large number of individual LEDs must be constructed.

Second, LEDs emit light in narrow optical bands. Hence, to provide a light source that a human observer will perceive as having a particular color, LEDs having different emission spectra must be combined into the same light source or phosphor conversion layers must be utilized to convert some of the LED generated light to light of a different spectrum. For example, an LED that is perceived to emit white light can be constructed by combining the output of LEDs having emission spectra in the red, blue, and green region of the spectrum or by utilizing a blue emitting LED and a layer of phosphor that converts some of the output light to light in the yellow region of the spectrum. For LCD displays, lights that have emission bands in the red, blue, and green regions of the spectrum are typically required. Hence, an LED-based light source must include three types of LEDs and provide for the mixing of the light from three separate sources.

Third, heat dissipation is particularly important in the case of LED-based light sources. The electrical conversion efficiency of an LED decreases with increasing junction temperature in the LED. Hence, any LED-based light source that generates a significant amount of heat must have a good thermal conduction path for removing the heat from the LED.

Finally, cost is of prime importance in most of these applications. In many prior art systems, the light source is constructed from individual LEDs that are incorporated on the printed circuit board (PCB) used to implement other parts of the mobile device. Such custom designs increase the cost of the design as well as the product cycle time. In addition, the efficiency with which the light from the light source is coupled into the light pipe affects the cost of the light source, since sources with poor light coupling efficiency require more LEDs to provide the same level of illumination. The efficiency of coupling also impacts the heat that must be dissipated, since the additional LEDs needed to overcome poor coupling efficiency also generate more heat that must be dissipated.

### BRIEF DESCRIPTION OF THE DRAWINGS

FIG. 1 is a top front perspective view of light source 30.

FIG. 2 is a bottom front perspective view of light source 30.

FIG. 3 is an exploded perspective view of light source 30 prior to encapsulating the individual LEDs.

FIG. 4 is a top view of light source 30.

FIG. 5 is a cross-sectional view of light source 30 through line 5-5 shown in FIG. 4 after the LEDs have been encapsulated.

FIGS. 6A and 6B illustrate two different dome encapsulation schemes.

FIG. 7 illustrates an embodiment in which the encapsulant layer includes two sub-layers.

FIG. 8A illustrates a connection scheme in which the individual LEDs of each color are connected in series.

FIG. 8B illustrates the connection scheme shown in FIG. 8A expanded to include an additional group of LEDs.

FIG. 9 is a top view of another embodiment of a light source according to the present invention.

FIG. 10 is a top view of a light source according to another embodiment of the present invention.

FIG. 11 is a cross-sectional view of a light source according to one embodiment of the present invention.

### SUMMARY OF THE INVENTION

The present invention includes a light source having a plurality of dies, an LED carrier, and a cover. Each die includes an LED, each die having a top surface, a bottom surface, and one or more side surfaces. The LED carrier includes a metallic core having a top and a bottom surface, the top surface is bonded to a circuit layer, and the dies are bonded to the circuit layer. The cover is bonded to the LED carrier. The cover includes a first opening that allows light from the LEDs to leave the cover, the opening having sides that slant inward such that light leaving a side surface of one of the dies is reflected by one of the sides out of the opening. A dome-shaped encapsulant layer covers each of the dies. The encapsulant layer is spaced from the sides of the opening such that there is an air gap between the encapsulant layers and the sides. The air gap is positioned such that light leaving the side surfaces of the dies passes through the air gap before being reflected by one of the sides. In one aspect of the invention, the bottom surface of the metal core includes an external surface of the light source and the light source can be attached to an external object using holes in the light source such that the bottom surface is in good thermal contact with the external object.

### DETAILED DESCRIPTION OF EMBODIMENTS OF THE INVENTION

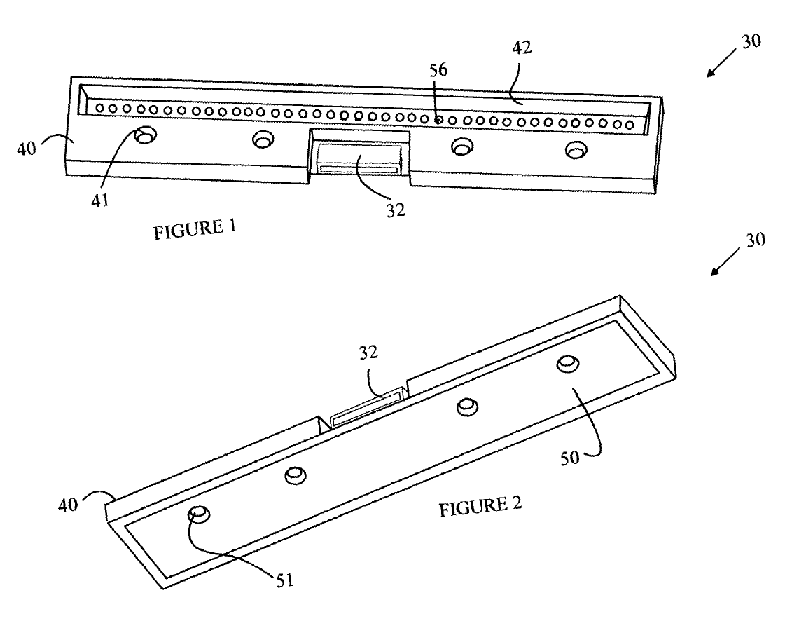

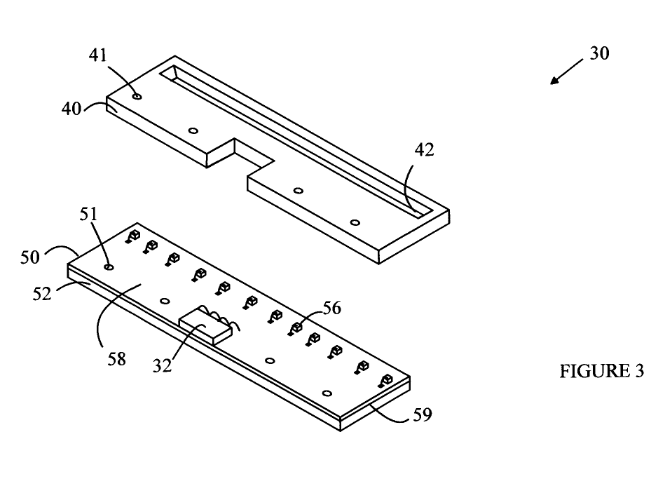

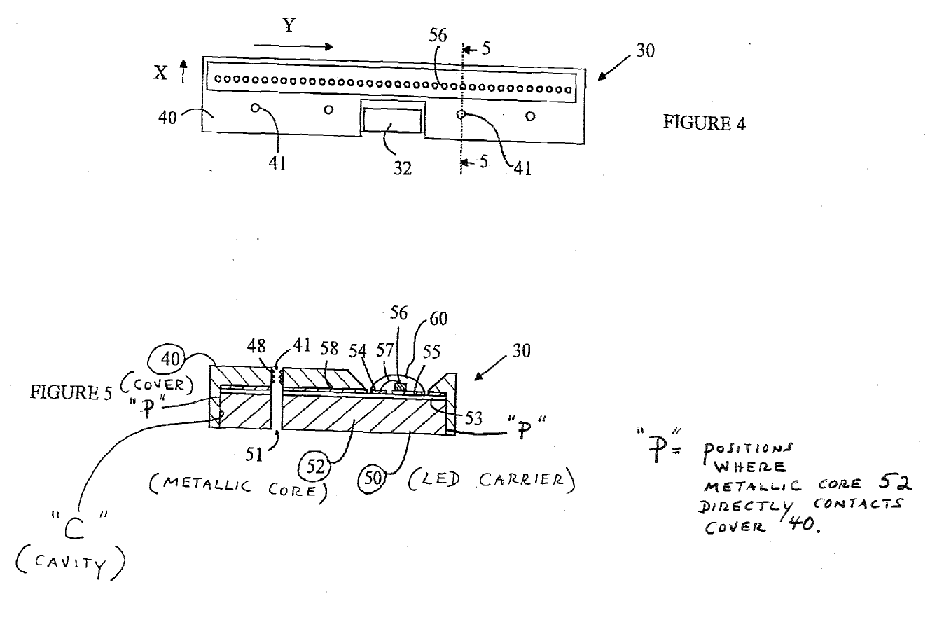

The manner in which the present invention provides its advantages can be more easily understood with reference to FIGS. 1-5, which illustrate one embodiment of a light source according to the present invention. FIG. 1 is a top front perspective view of light source 30, and FIG. 2 is a bottom front perspective view of light source 30. FIG. 3 is an exploded perspective view of light source 30 prior to encapsulating the individual LEDs. FIG. 4 is a top view of light source 30, and FIG. 5 is a cross-sectional view of light source 30 through line 5-5 shown in FIG. 4 after the LEDs have been encapsulated.

Light source 30 includes two main assemblies, a LED carrier 50 and a cover 40. Cover 40 includes a cavity into which LED carrier 50 is inserted. Cover 40 also includes an opening 42 through which light from the LEDs shown at 56 can exit light source 30. The sides of opening 42 are reflective and slanted at an angle to redirect light leaving the LEDs through the side thereof to a direction that allows that light to exit from light source 30.

LED carrier 50 is a circuit carrier 59 that is constructed from one or more metal layers that are patterned to provide the connections between the various electronic components in light source 30. The circuit layers are bonded to a metal core 52 that transfers heat from the LEDs to cover 40 and to the underlying structures on which light source 30 is mounted. In one embodiment, the core is constructed from an aluminum alloy. In another embodiment, the core is constructed from a material having a thermal conductivity greater than 10 W/m.K at 25 degrees Centigrade. In the embodiment shown in FIGS. 1-5, a single metal layer is patterned to provide the traces 54 and 55 used to connect LED 56 to power through connector 32. This layer is separated from core 52 by a thin insulating layer 53 that is less than or equal to 4 mils thick. The metal layer is covered by a second thin insulating layer 58 that prevents the signal traces in the metal layer from shorting to cover 40.

The connector can be either a male or female connector that is configured to mate to a corresponding connector on a cable or other device in the apparatus in which the light source is utilized. In the above-described embodiments, the connector is positioned to receive the corresponding connector in a direction parallel to the surface of the LED circuit carrier. However, embodiments in which the connector is mounted such that the corresponding connector is received in a direction perpendicular to that surface could also be constructed.

Each LED is connected to two traces within the metal layer. The first connection is provided by a terminal on the bottom of the LED, and the second connection is provided by a terminal on the top of the LED through a wire bond connection 57.

Each LED in light source 30 is encapsulated in a dome-shaped layer of clear material as shown at 60. This layer serves a number of functions. First, the layer protects LED 56 and wire bond 57 from environmental factors. The LED die must be protected from moisture. In addition, the wire bond is fragile. In this regard, it should be noted that if all of the LEDs are encapsulated in a single layer of encapsulant the mechanical stress on the wire bonds when the layer of encapsulant is heated is significantly greater than the stress to which each wire bond is subjected when the dies are individually encapsulated.

Second, the layer can be used as a carrier for phosphors, luminescent materials, or dyes. In phosphor-converted LEDs, all or part of the light emitted by the LED is converted to light of a different spectrum by phosphor particles or luminescent materials that are typically suspended in a layer of clear encapsulant that is applied over the LEDs. In the case of a dye, the light from the LED is filtered to provide light having a more limited spectrum than that generated by the LED.

Finally, and most importantly, the dome-shaped layer improves the extraction of the light from the LED. As noted above, a significant fraction of the light generated in the active layer of the LED is trapped within the LED by internal reflection at the surface of the LED due to the large difference in the index of refraction between the LED and air. This light is either absorbed in the LED material or exits the die through a side surface of the die. The reflector captures the light that exits through the side surface and redirects the light to the forward direction. However, a significant fraction of the trapped light is lost to absorption before the light can exit the die. Hence, it is advantageous to reduce the amount of light that is trapped by internal reflection.

The dome-shaped layer reduces the amount of light that is trapped through two mechanisms. First, the light that is trapped is light that strikes the LED surface at angles greater than the critical angle with respect to the normal to that surface. The critical angle, in turn, depends on the ratio of the indices of refraction between the LED and the material on the other side of the surface. If a material having an index of refraction that is intermediate between that of air and the LED materials is applied to the surface, the critical angle is increased, and hence, a significant amount of the light that would have been lost now passes out of the LED and into the applied layer. Second, the dome shape assures that substantially all of the light that enters the applied layer strikes the boundary between the applied layer and air at angles less than the critical angle with respect to that surface, and hence, escapes the applied layer. If the applied layer did not have the dome shape, a significant fraction of the light that entered that layer would be trapped in that layer.

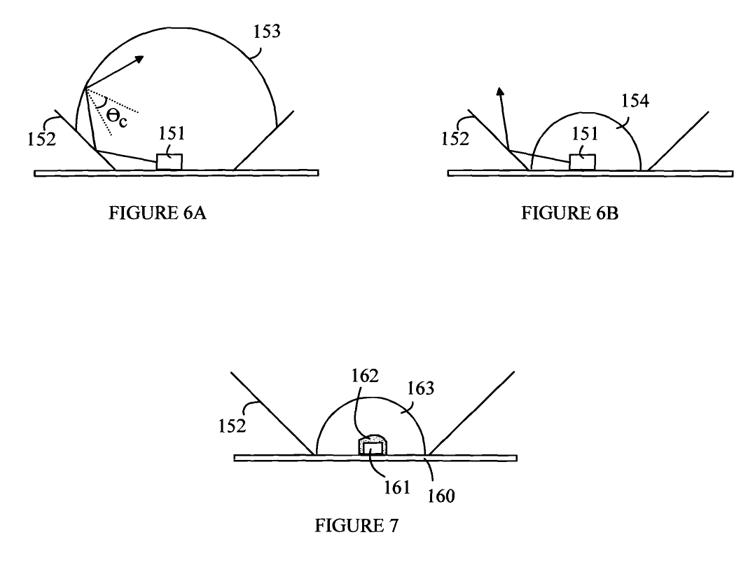

In effect, the dome-air interface provides the extraction function for assuring that light that enters the encapsulant layer will exit the encapsulant layer. This function, however, assumes that the source of the light that strikes the dome surface is the LED die. Refer now to FIGS. 6A and 6B, which illustrate two different dome encapsulation schemes. FIG. 6A illustrates a dome encapsulation scheme in which a die 151 is located inside a dome 153 that also covers a portion of reflector 152. The light leaving the side surface of die 151 strikes the reflector before striking the surface of dome 153. The reflection alters the angle at which the light strikes the surface of the dome such that the light now strikes the dome surface at an angle that is greater than the critical angle, θ_{c}, with respect to the normal to the surface of dome 153, and hence, the light is internally reflected and does not escape the dome. Eventually, some of this light will escape the dome after a number of additional reflections; however, the increased path length and additional reflections result in absorption of a portion of the light. Refer now to FIG. 6B, which illustrates an encapsulation scheme in which the dome 154 is constructed in a manner that leaves an air gap between the dome and the reflector. In this case, the light from LED 151 first strikes dome 154 at an angle that is less than the critical angle, and hence, the side emitted light escapes. After the light escapes, the light strikes reflector 152 and is re-directed into the forward direction. Accordingly, in one embodiment of the present invention, the dome structure is separated from the reflector by an air gap such that light leaving the side surface of the die exits the encapsulation dome before striking the reflector.

The above-described embodiments of the present invention utilize a single layer of encapsulant. However, embodiments in which the encapsulating medium includes multiple layers can also be constructed. Refer now to FIG. 7, which illustrates an embodiment in which the encapsulant layer includes two sub-layers. In this embodiment, die 161 is encapsulated between substrate 160 and a first sub-layer 162. The encapsulated die is then covered with a dome-shaped layer 163 that provides the light extraction function discussed above. Sub-layer 162 could include a material that alters the spectrum of light from that emitted by die 161. For example, sub-layer 162 could include a phosphor or luminescent material that absorbs all or a portion of the light from LED 161 and emits light of a different spectrum. In addition, sub-layer 162 could include a dye that absorbs light in a portion of the spectrum without re-admitting the light in the optical region of the spectrum. The phosphors or luminescent materials could be in particulate form or soluble in the material of sub-layer 162. Since such materials emit light in all directions after being excited by the light from LED 161, the apparent size of the light source is altered to the size of sub-layer 162. Accordingly, the size of dome-shaped sub-layer 163 should be sufficient to assure that substantially all of the light leaving sub-layer 162 will strike the dome-shaped surface at angles less than the critical angle with respect to the air-encapsulant boundary of sub-layer 163.

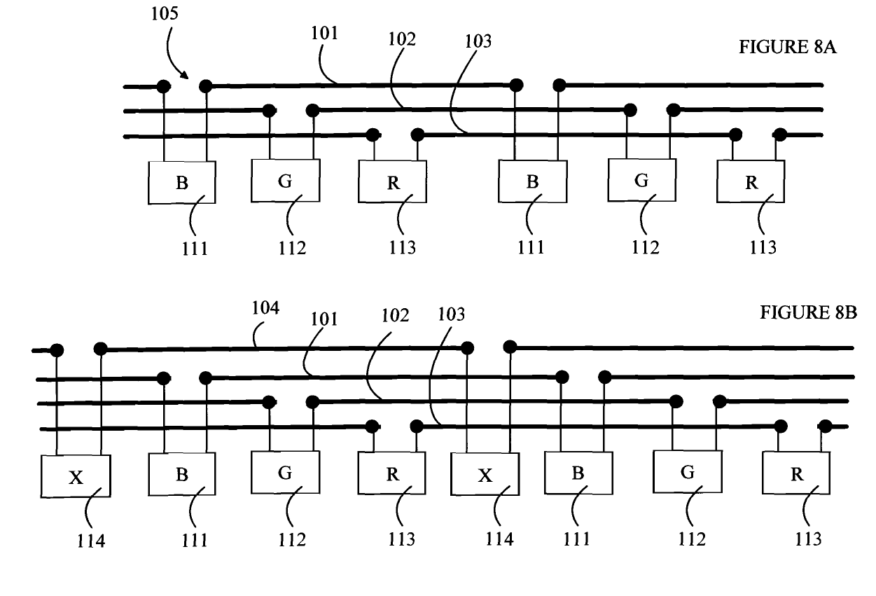

Refer now to FIG. 8A, which illustrates a connection scheme in which the individual LEDs of each color are connected in series. In this arrangement, the metal layer shown in FIG. 5 includes three metal traces 101-103 that include gaps such as gap 105 at each point at which an LED is to be connected. All of the blue LEDs 111 are connected to trace 101 such that the LED completes the circuit across one of the gaps in trace 101. Similarly, the green LEDs 112 are connected across the gaps in trace 102, and the red LEDs 113 are connected across the gaps in trace 103. The ends of each trace are connected to conductors in connector 32.

While the embodiment shown in FIG. 8A has 3 groups of LEDs, embodiments having other numbers of groups are also useful in particular situations. For example, a monochrome source requires only one group of LEDs. Furthermore, embodiments that have 4 groups of LEDs provide a number of advantages. Refer now to FIG. 8B, which illustrates the connection scheme shown in FIG. 8A expanded to include an additional group of LEDs, denoted by “X”. The additional group is implemented by providing an additional conductor 104 that has gaps for the new group of LEDs shown at 114.

In one embodiment, X is an additional green LED. The relative efficiency of green LEDs is significantly less than that of red and blue LEDs. Hence in embodiments in which the LEDs are to be operated close to the maximum rated currents, additional green LEDs are needed to provide the same range of colors and still maintain the red and blue LEDs at near the maximum current for those LEDs.

In another embodiment, X is a “white” LED. White LEDs, based on blue LEDs that are covered by a yellow phosphor that converts part of the blue light to yellow light, have a higher power conversion efficiency than white light sources constructed from red, blue, and green LEDs. However, in many applications, a white light source that has a limited range of color tuning around the white light provided by the white LED is useful.

In yet another embodiment, X is an amber or cyan LED. Such light sources have a wider color gamut, and hence are useful in specific applications that require color points in the amber or cyan regions of the color space.

The minimum width of the embodiments discussed above is determined by the size of opening 42 shown in FIG. 3 and the size of connector 32. If a light source with a reduced width is required, connector 32 can be placed at the end of the row of LEDs such that the connector does not increase the width or length of the light source.

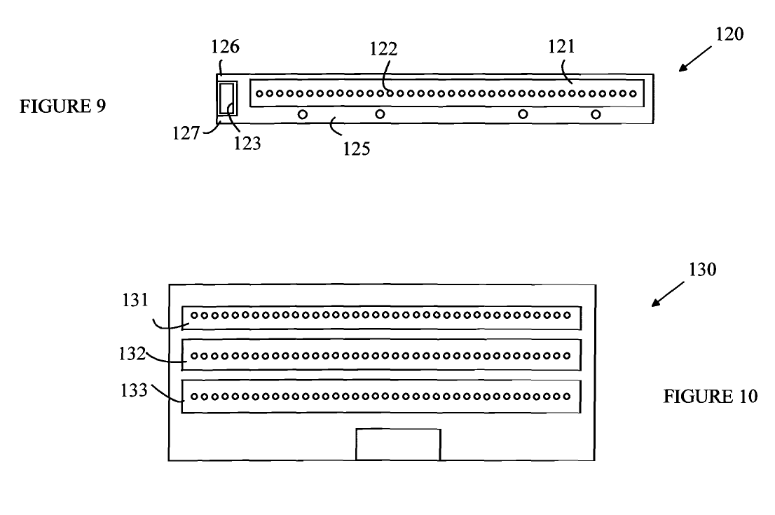

Refer now to FIG. 9, which is a top view of another embodiment of a light source according to the present invention. Light source 120 includes a plurality of LEDs 122 positioned in an opening 121 in cover 125. The LEDs are arranged on a circuit carrier that is analogous to that described above. The traces on the circuit carrier are connected to a connector 123 that is positioned in an opening in cover 125 on the end of cover 125.

While connector 123 is shown as being inset in an opening in cover 125 having three sides, it should be noted that sides 126 and 127 are optional. That is, cover 125 could merely terminate leaving the portion of the underlying circuit carrier having the connector pads exposed.

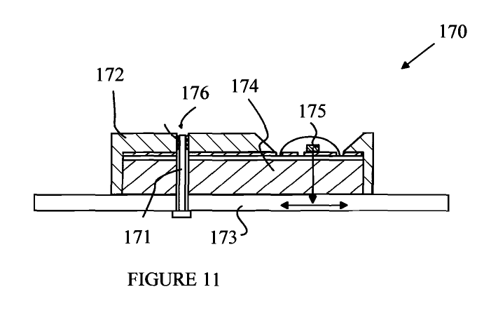

The above-described embodiments of the present invention utilize an arrangement having one row of LEDs. However, embodiments having multiple rows of LEDs could also be constructed. Refer now to FIG. 10, which is a top view of a light source according to another embodiment of the present invention. Light source 130 includes three rows of LEDs as shown at 131-133. Each row of LEDs is surrounded by a reflector of the type discussed above.

As noted above in the discussion of FIGS. 1-5, the cover and carrier may include holes 41 and 51 that include a threaded section 48. The holes can be utilized to bond the cover to the base section using a threaded connector if adhesive bonding is not utilized. In addition, the holes can be utilized to connect the light source to an underlying surface to facilitate the transfer of heat from the LEDs to the surface in question. Refer now to FIG. 11, which is a cross-sectional view of a light source according to one embodiment of the present invention. Light source 170 includes a threaded hole 176 in cover 172 that is aligned with a hole in carrier 174 such that a bolt 171 can be used to connect light source 170 to substrate 173 with sufficient force to facilitate the transfer of heat from LEDs 175 to substrate 173.

The above-described embodiments of the present invention utilize a dome-shaped encapsulant layer over each die. For the purposes of this application, a layer will be defined to be “dome-shaped” if the layer has a convex surface opposite the surface of the LED that is emitting the light, and the radius of curvature of the surface is such that light exiting that surface of the LED will strike the surface at angles relative to the normal to the surface that allow the light to escape through the surface of the dome-shaped layer. In general, the light leaving the surface of the LED is confined to a cone of angles about the normal to that surface. The cone of angles is determined by the difference in index of refraction between the material from which the LED is constructed and the encapsulant material. Similarly, the cone of angles about the normal to the dome-shaped surface through which light can exit that layer depends on the index of refraction of the encapsulant material and air. The light that escapes the dome will also depend somewhat on the location on the die at which the light exits the die, since the dies have a finite size.

In the above discussion, a layer is said to encapsulate an object if that layer together with a layer of impermeable material to which the object is attached surrounds the object. Hence, a die that is bonded to a first surface and covered by a layer of material will be defined to be “encapsulated” by the layer of material.

Various modifications to the present invention will become apparent to those skilled in the art from the foregoing description and accompanying drawings. Accordingly, the present invention is to be limited solely by the scope of the following claims.

1. A light source comprising:
a plurality of dies, each die comprising an LED, each die having a top surface, a bottom surface, and one or more side surfaces;
an LED carrier comprising a metallic core having a top and a bottom surface, said top surface being bonded to a circuit layer, said dies being bonded to said circuit layer;
a cover bonded to said LED carrier, said cover comprising a cavity therein, said metallic core of said LED carrier being at least partially positioned within said cavity, said cover further comprising a first opening that allows light from said LEDs to leave said cover, said opening having sides that slant inward such that light leaving a side surface of one of said dies is reflected by one of said sides out of said opening, said metallic core further comprising at least a portion thereof which is in direct contact with at least part of said cover; and
a dome-shaped encapsulant layer over each of said dies, said encapsulant layer being spaced from said sides of said opening such that there is an air gap between said encapsulant layer and said sides, said air gap being positioned such that light leaving said side surfaces of said dies passes through said air gap before being reflected by one of said sides.

2. The light source of claim 1 wherein said bottom surface of said metallic core comprises an external surface of said light source.

3. The light source of claim 1 wherein said circuit layer comprises mounting pads to which said dies are bonded and wherein said light source further comprises a connector that provides connections to circuit conductors connected to said mounting pads; and a second opening in said cover that provides access to said connector.

4. The light source of claim 1 wherein said metallic core has a thermal conductivity greater than 10 W/m.K at 25 degrees Centigrade.

5. The light source of claim 1 wherein said cover comprises aluminum plated with nickel on a surface of said first opening.

6. The light source of claim 3 wherein said circuit layer comprises a thermally conductive insulator having a thickness of less than 4 mils having a first surface bonded to said metallic core and a second surface bonded to said circuit conductors.

7. The light source of claim 1 wherein said dome-shaped encapsulant comprises a first encapsulant having a material that converts light emitted by said LED encapsulated by said first encapsulant to light of a different wavelength and a second clear encapsulant overlying said first encapsulant.

8. The light source of claim 2 further comprising first and second holes in said cover and said LED carrier, said first and second holes in said cover being aligned with said first and second holes in said LED carrier such that said external surface of said light source is bonded to an external object when fasteners are connected through said holes and said external object.

9. The light source of claim 1 wherein said dies are arranged in a linear array having at least one row of LEDs that is parallel to one side of said first opening.
